(19) United States
(12) Patent Application Publication
(10) Pub. No.: US 2005/0251406 A1
(43) Pub. Date: Nov. 10, 2005

(54) Method and system for classifying a plurality of records associated with an event

(76) Inventors: George Bolt, Hampshire (GB); John Manslow, Hampshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/086,981

(22) Filed: Mar. 21, 2005

Related U.S. Application Data
(63) Continuation of application No. PCT/AU03/01240, filed on Sep. 22, 2003.

(30) Foreign Application Priority Data
Sep. 20, 2002 (GB) 0221925.1

(51) Int. Cl. G06F 17/60

(52) U.S. Cl. 705/1; 705/10

(57) ABSTRACT

A method and system for classifying a plurality of records associated with an event are disclosed. In one embodiment, the system comprises a receiver configured to receive a plurality of event data records, an extractor configured to extract numeric values from each event data record, and a classifier unit configured to classify the numeric values of each event data record to produce a propensity value associated with each event data record. In use the system receives the event data records. The extractor extracts numeric values from each event data record. The classifier unit classifies the numeric values of each event data record to produce a propensity value associated with each event data record. The propensity value is used as a probability that an event associated with each data records satisfies a criterion.

### RELATED APPLICATIONS

This application is a continuation application, and claims the benefit under 35 U.S.C. §§ 120 and 365 of PCT Application No. PCT/AU2003/001240, filed on Sep. 22, 2003 and published Apr. 1, 2004, in English, which is hereby incorporated by reference.

### BACKGROUND OF THE INVENTION

1. Field of the Invention

The present invention relates to a method of classifying events and a system for performing the method. The present invention has application in assisting classification of records associated with an event, including, but not limited to events such as fraudulent use of a telecommunications network.

2. Description of the Related Technology

Fraud is a serious problem in modern telecommunications systems, and can result in revenue loss by the telecommunications service provider, reduced operational efficiency, and an increased risk of subscribers moving to other providers that are perceived as offering better security. Once a fraud has been identified, the operator is faced with the problem of removing fraudulent calls from the archive of events for all subscribers that were victims of the fraud. This archive typically contains information relating to at least the type of event (e.g. a telephone call), the time and date at which it was initiated, and its cost. Because the archive is used for billing, failure to remove fraud events can result in customers being charged for potentially very expensive events that they did not initiate.

Currently, telecommunications service providers make little effort to remove individual fraud events from the archive and instead remove large blocks of events that occurred around the time that the fraud took place in the hope that all fraud events will be removed. While this can be done very quickly, it is highly inefficient because business and corporate customers frequently initiate hundreds of events per day, and the removal of an entire month's worth of events from the archive means that the service provider loses revenue by failing to charge subscribers for events that they did initiate and hence could legitimately be charged for.

The alternative to removing large blocks of events form the archive is for fraud analysts to manually examine each and every event in the archive. This is extremely labor intensive, and would greatly increase the time required to process each fraud. Also, in marginal cases, where the fraudulent behavior is not clearly distinct from a subscriber's normal behavior, many errors are likely to result, producing the expected penalty in customer relations when attempts are made to charge for fraudulent calls.

Accurate classification of individual events in the event archive is also becoming increasingly important as fraud detection systems move towards using feedback from the outcomes of fraud investigations to improve accuracy of their fraud detection engines. If accurate classification of individual events in the event archive can be performed, the quality of the information that can be fed back will be greatly enhanced, increasing the improvements in performance that the feedback makes possible.

### SUMMARY OF CERTAIN INVENTIVE ASPECTS

One aspect of the invention provides a method of classification of a plurality of records associated with an event, comprising: providing a plurality of event data records; extracting numeric values from each event data record; and classifying the numeric values of each event data record to produce a propensity value associated with each event data record, wherein the propensity value is used as a probability that an event associated with each event data record satisfies a criterion.

In one embodiment, the method further comprises: providing suspect behavior alerts generated in response to one or more of the event data records potentially being generated by the criterion sought; and preprocessing the suspect behavior alerts to remove alerts that are false positives.

Another aspect of the invention provides a system for assisting in retrospective classification of stored events, comprising: a receiver of a plurality of event data records; an extractor for extracting numeric values from each event data record; and a classifier unit for classifying the numeric values of each event data record to produce a propensity value associated with each event data record, the propensity value being a probability that an event associated with each event data record satisfies a criterion.

In one embodiment, the system further comprises: a receiver for suspect behavior alerts generated in response to one or more of the event data records potentially being generated by a sought criterion; and a preprocessor for preprocessing the suspect behavior alerts to remove alerts that are false positives.

In the above aspects the criterion being sought may be a fraud event.

Another aspect of the invention provides a method of assisting retrospective classification of a plurality of stored records, each record associated with an event, the method comprising: providing a plurality of event data records; providing suspect behavior alerts generated in response to one or more of the event data records potentially being generated by a fraud; preprocessing the suspect behavior alerts to remove alerts that are false positives; extracting numeric values from each event data record; classifying the numeric values of each event data record to produce a propensity value associated with each event data record, the propensity value being a probability that an event associated with each event data record is suspicious, wherein the propensity value is of assistance in classifying each event as suspicious or not.

In one embodiment, the event data records are generated within a telecommunications network and contain data pertaining to events within the network. In one embodiment, the event data records are archived in a data warehouse.

In one embodiment, a fraud detection system generates suspect behavior alerts in response to one or more event data records being considered to be potentially from fraudulent use of the network. In one embodiment, a suspect behavior alert is generated in response to either an individual event data record or a group of event data records, or both.

In one embodiment, the suspect behavior alert includes data associated with an event data record that indicates which components of the fraud detection engine consider the event data record to be suspicious.

In one embodiment, the preprocessing step uses all suspect behavior alerts and event data records associated with the service supplied to a particular subscriber of the service. In one embodiment, the preprocessing step also uses a list of event data records that are known not to be part of the fraud (clean records) and a list of event data records that are known to be part of the fraud.

In one embodiment, the preprocessing comprises one or more the following: (a) removing suspect behavior alerts that correspond to event data records known to be clean; (b) dividing the suspect behavior alerts into contiguous blocks where at least a minimum number of suspect behavior alerts were generated for each event data record; (c) removing suspect behavior alerts where there is less than a threshold number of suspect behavior alerts for each event data record in each contiguous block of event data records; and (d) removing suspect behavior alerts that are part of one of the blocks that contains fewer suspect behavior alerts than a percentile of the lengths of all contiguous blocks of suspect behavior alerts.

In one embodiment, the minimum number of suspect alerts is 1. In one embodiment, the threshold number is 2.

In one embodiment, (d) is applied prior to (a) and (c) in noisy environments. Alternatively, if the number of blocks of suspect behavior alerts produced by (a) and (c) is small, then (d) is omitted.

In one embodiment, the numeric value extracted from data is through the application of one or more linear or non-linear functions.

In one embodiment, the classification comprises applying one or more classifying methods to the numeric values. In one embodiment, the classifying methods include using one of more of the following: a supervised classifier, an unsupervised classifier and a novelty detector.

In one embodiment, the supervised classifier method uses features extracted from both the clean records, the known fraud records, and the event data records associated with preprocessed suspect behavior alerts to build classifiers that are able to discriminate between known frauds and non-frauds. In one embodiment, the supervised classifier is one or more of the following: a neural network, a decision tree, a parametric discriminant, semi-parametric discriminant, or non-parametric discriminant.

In one embodiment, the unsupervised classifier method decomposes the extracted data into subsets that satisfy selected statistical criteria to produce event data record subsets. The subsets are then be analyzed and classified according to their characteristics. In one embodiment, the unsupervised algorithm is one or more of the following: a self-organizing feature map, a vector quantizer, or a segmentation algorithm.

In one embodiment, when a fraud occurs without any suspect behavior alerts having been generated, the preprocessor is omitted, and only the unsupervised classifier method and/or the novelty detector methods are used within the classification.

In one embodiment, the novelty detection algorithm uses either a list of clean data records or a list of fraud event data records. The novelty detection algorithm builds models of either non-fraudulent or fraudulent behavior and searches the remaining extracted data for behavior that is inconsistent with these models.

In one embodiment, the novelty detection algorithm searches for feature values that are beyond a percentile of the distribution of values of the feature in the clean event data records. Alternatively the novelty detection algorithm produces a model of the probability density of values of a feature, or set of features, and searches for event data records where the values lie in a region where the density is below a threshold.

In one embodiment, the outputs of the classifiers are scaled to lie in the interval [0,1].

In one embodiment, a plurality of classifying method are used. In one embodiment, the outputs of the classifier methods are combined into a single propensity measure that is associated with each event data record, the propensity measure indicating the likelihood that each event data record was generated in response to a fraudulent event.

In one embodiment, the propensities are calculated from a weighted sum of the outputs of the classifiers. Alternatively if there are no event data records that are known to be fraudulent or no event data records that are known to be clean, the outputs of all classifiers are combined equally. Alternatively the combination of weights that minimizes a measure of the error between the combined propensities over clean and fraud event data records and an indicator variable that takes the value zero for a clean event data record and one for a fraud event data record.

In one embodiment, a fraud analyst can revise the lists of clean and fraud event data records from the received the propensities. In another embodiment, the method can be reapplied to get a revised set of propensities.

Another aspect of the invention provides a system for assisting retrospective classification of a plurality of stored records, each record associated with an event, the system comprising: a receiver for a plurality of event data records and suspect behavior alerts generated in response to one or more of the event data records potentially being generated by a fraud; an extractor for extracting numeric values from each event data record; and a classifier unit for classifying the numeric values of each event data record to produce a propensity value associated with each event data record, the propensity value being a probability that an event associated with each event data record is suspicious or not.

In one embodiment, the system further comprises a preprocessor for removing suspect behavior alerts that are false positives;

In one embodiment, the event data records are generated within a telecommunications network and contain data pertaining to events within the network.

In one embodiment, the event data records are archived in a data warehouse and are provided to the receiver.

In one embodiment, the preprocessor is arranged to receive all suspect behavior alerts and event data records associated with the service supplied to a particular subscriber of the service.

In another embodiment, the preprocessor is also arranged to receive a list of event data records that are known not to be part of the fraud (clean records) and a list of event data records that are known to be part of the fraud.

In one embodiment, the preprocessor comprises a means for removing suspect behavior alerts that correspond to event data records known to be clean.

In one embodiment, the preprocessor comprises a means for dividing the suspect behavior alerts into contiguous blocks where at least a minimum number of suspect behavior alerts were generated for each event data record. In another embodiment, the preprocessor comprises a means for removing suspect behavior alerts where there is less than a threshold number of suspect behavior of alerts for each event data record in each contiguous block of event data records. In another embodiment, the preprocessor comprises a means for removing suspect behavior alerts that are part of one of the blocks that contains fewer suspect behavior alerts than a percentile of the lengths of all contiguous blocks of suspect behavior alerts.

In one embodiment, the system further comprises a means for extracting a numeric value from data is through the application of one or more linear or non-linear functions.

In one embodiment, the classifier unit comprises a supervised classifier. In one embodiment, the classifier comprises an unsupervised classifier. In another embodiment, the classifier comprises a novelty detector.

In one embodiment, the supervised classifier is one or more of the following: a neural network, a decision tree, a parametric discriminant, semi-parametric discriminant, or non-parametric discriminant.

In one embodiment, the unsupervised classifier is one or more of the following: a self-organizing feature map, a vector quantizer, or a segmentation algorithm.

In one embodiment, the novelty detector includes a means for searching for feature values that are beyond a percentile of the distribution of values of the feature in the clean event data records.

In one embodiment, the classifier unit comprises a plurality of classifiers. In one embodiment, the system further comprises a combiner for combining the outputs of the classifiers into a single propensity measure that is associated with each event data record component.

### BRIEF DESCRIPTION OF THE DRAWINGS

In order to provide a better understanding, embodiments of the present invention will now be described in greater detail, by way of example only, with reference to the accompanying diagrams, in which:

FIG. 1 is a schematic representation according to one embodiment of the invention;

FIG. 2 illustrates a preprocessing procedure according to one embodiment of the invention;

FIG. 3 shows an example of an output according to one embodiment of the invention.

### DETAILED DESCRIPTION OF CERTAIN INVENTIVE EMBODIMENTS

One embodiment of the present invention may take the form of a computer system programmed to perform the method of the present invention. The computer system may be programmed to operate as components of the system of the present invention. Alternatively suitable means for performing the function of each component may be interconnected to form the system. The system for assisting in retrospective classification of stored events comprises a receiver of a plurality of event data records; an extractor for extracting numeric values from each event data record; and a classifier for classifying the numeric values of each event data record to produce a propensity value associated with each event data record. The propensity value may be used to indicate the likelihood that an event associated with each event data record satisfies a criterion. The invention has particular application when the criterion being sought is a fraudulently generated event, more particularly a fraudulent use of a telecommunications network. However a skilled addressee will be able to readily identify other uses of the present invention.

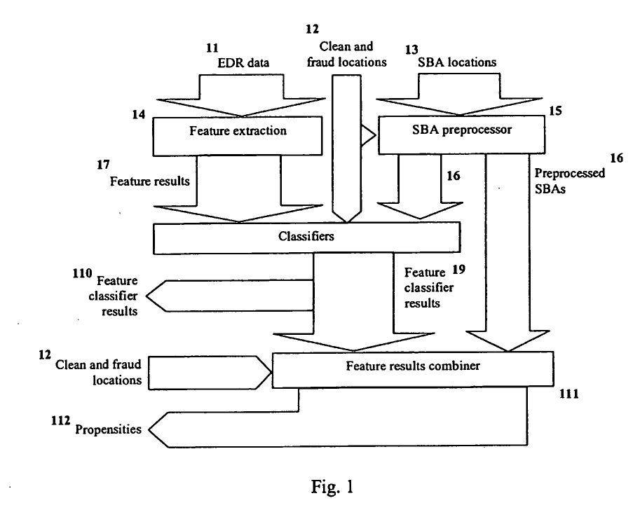

In FIG. 1 a preferred embodiment of the system of the present invention is shown. The system includes a receiver of event data records 11, a receiver of records known to be clean (not fraudulent) 12 and records known to be fraudulent 12, and a receiver of suspect behavior alerts 13.

The event data records 11 (EDRs) are generated within a telecommunications network and contain data pertaining to events within the network (such as telephone calls, fax transmissions, voicemail accesses, etc.). The EDRs are archived in a data warehouse. An EDR typically contains information such as the time of occurrence of an event, its duration, its cost, and, if applicable, the sources and destinations associated with it. For example, a typical EDR generated by a telephone call is shown in table 1, and contains the call's start time, its end time, duration, cost, the telephone number of the calling party, and the telephone number of the called party. Note that these numbers have been masked in this document in order to conceal the actual identities of the parties involved. This invention can also be used if entire EDRs are not archived. For example, in one embodiment, only the customer associated with an event and one other data item per EDR (such as the time of the event) are required to use the invention.

TABLE 1

| CDR Field | Value |
|---|---|
| Calling number | 11484XXXX |
| Called number | 11789XXXX |
| Call cost | 1 |
| Call duration | 92 |
| Start date | May 05, 1998 |
| Start time | 11:13:28 |

It is also assumed that a fraud detection system generates suspect behavior alerts 13 (SBAs) in response to either individual EDRs, groups of EDRs, or both. A SBA contains data associated with an EDR that indicates which components of the fraud detection engine consider the EDR to be suspicious. For example, a fraud detection engine may contain many rules, a subset of which may fire (indicating a likely fraud) in response to a particular EDR. By examining which rules fired in response to an EDR, a fraud analyst gets an indication of how the behavior represented by the EDR is suspicious.

For example, if a rule like ‘More that 8 hours international calling in a 24 hour period’ fires it is clear that there has been an abnormal amount of time spent connected to international numbers. SBAs may contain additional information, such as a propensity, which can provide an indication of the strength with which a rule fires. For example, the aforementioned rule may fire weakly (with low propensity) if 9 hours of international calling occurs in a 24 hour period, but more strongly (with a higher propensity) if 12 hours of calling occurs. Note that several SBAs may be associated with each EDR if several components within the fraud detection engine consider it to be suspicious. For example, several rules may fire for an EDR, each generating their own SBA.

An SBA generated in response to a particular EDR indicates that the event that led to the EDR's creation was likely to have been fraudulent. Some fraud detection systems also generate SBAs that are associated with groups of EDRs because they analyze traffic within the network over discrete time periods. For example, some systems analyze network traffic in two hour blocks, and, if a block appears abnormal in some way—perhaps because it contains large numbers of international calls—an SBA is generated that is associated with the entire two hour block of EDRs rather than any particular EDR. These SBAs indicate that a fraudulent event may have occurred somewhere within the associated time period, but provide no information as to which specific EDRs within it were part of the fraud. It is further assumed that the SBAs generated by the system are stored in a data warehouse along with information about which EDRs or groups of EDRs they are associated with.

The SBAs received at 13 and EDRs received at 11 are all associated with the service supplied to a particular subscriber. They are extracted from the data warehousing systems and presented to the system 10. The list of clean EDRs received at 12 is EDRs that are known not to be part of a fraud. The fraud EDRs also received at 12 are EDRs that are known to be part of the fraud. The SBAs received at 13 are presented to a preprocessor component 15, which attempts to remove false positive SBAs (those that correspond to events that are not fraudulent).

The preprocessor 15 comprises three stages. Firstly, any SBAs 13 that correspond to EDRs in the list of clean EDRs 12 are removed because the invention is being instructed that the ‘suspect behavior’ responsible for them is normal.

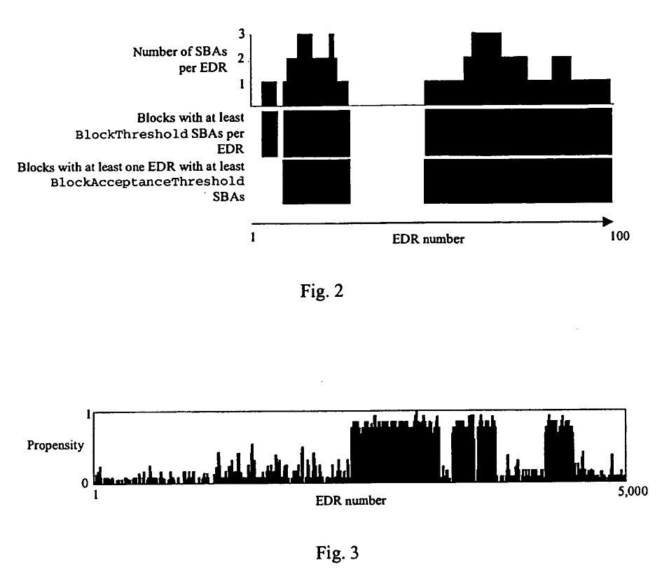

Secondly, a two-stage filtering process is used whereby the EDRs are divided into contiguous blocks where at least threshold of SBAs (BlockThreshold) were generated per EDR. Each of these blocks is examined, and a preprocessed SBA 16 produced for every EDR in a block where more than an acceptance threshold of SBAs (BlockAcceptanceThreshold) have been produced for at least one EDR within it. In other words if SBAs are removed if they do not have the BlockAcceptanceThreshold number of SBAs for all the EDRs in the block. An example of this process is illustrated in FIG. 2 for values of BlockThreshold and BlockAcceptanceThreshold of one and two, respectively. BlockThreshold and BlockAcceptanceThreshold are parameters that are used to control the behavior of the SBA preprocessor 15, and values of one and two have been found to work well in practice, though different values may be necessary for different fraud detection engines. For example, if a fraud detection engine contains large numbers of noisy components (e.g. lots of rules that generate lots of SBAs for clean EDRs) these values may need to be increased.

The third operation performed by the preprocessor 15 is to filter the preprocessed SBAs 16 according to the lengths of the contiguous blocks within which they occur. This is done by removing blocks of preprocessed SBAs 16 that are part of a block that contains fewer preprocessed SBAs 16 than a percentile of the lengths of all contiguous blocks of preprocessed SBAs 16. For example, if the 50^{th} percentile is chosen as the cut-off point, only preprocessed SBAs 16 that form a contiguous block longer than the median length of all such blocks will be passed out of the preprocessor 15.

This final stage can be useful when the preprocessor 15 is receiving SBAs 13 from a fraud detection engine with many noisy components, because these will frequently cause the first two stages of the preprocessor 15 to generate very short spurts of spurious SBAs. In exceptionally noisy environments, the robustness of the preprocessor 15 can be further improved by applying this third step to the SBAs from each source (e.g. to the SBAs produced by each rule in a fraud detection engine) prior to the first step of SBA preprocessor processing. Alternatively, if the number of blocks of preprocessed SBAs 16 produced by the first two steps in the preprocessor is small, the third step may be omitted altogether. The number of blocks is usually considered to be small if it is such that the percentile estimate used in step (d) is likely to be unreliable.

Before the preprocessed SBAs 16 can be used (they are treated as known frauds from this point onwards), a feature extraction component 14 needs to extract features 17 from the EDR data 11 that can be used by a classifier 18. The word ‘feature’ is used here in the sense most common in the neural network community, of a numeric value extracted from data through the application of one or more linear or non-linear functions. Possibly the simplest type of feature is one that corresponds directly to a field in the data. For example, the cost of a call is usually a field within EDRs and is useful in identifying fraudulent calls because they tend to be more expensive than those made by the legitimate subscriber. The time of day of the start of an event represents a more complex feature because time is often represented in EDRs as the number of seconds that an event occurred after some datum—typically 1 Jan. 1970. The time of day feature must thus be calculated by performing a modular division of the time of an event by the number of seconds in a day.

Once all features 17 have been extracted, they are passed to classifiers in the classifier unit 18. The classifier unit 18 receives additional inputs in the form of preprocessed SBAs 16 from the preprocessor 15, a list of clean EDRs 12 and a list of fraud EDRs 12. There are typically a range of supervised and unsupervised classifiers along with novelty detectors, each of which perform a different classification method. Supervised classifier components use features extracted from both the clean EDRs 12, the fraud EDRs 12, and the EDRs associated with preprocessed SBAs 15 to build supervised classifier components that are able to discriminate between known frauds and non-frauds. Any supervised classifier (such as a neural network, a decision tree, a parametric, semi-parametric, or non-parametric discriminant, etc.) can be used, although some will be too slow to achieve the real time or near real time operation that is required for one embodiment of the invention to be interactive.

Occasionally, a fraud may occur without any SBAs 13 having been generated at all, with the fraud analyst knowing of no EDRs 11 that are part of the fraud, or knowing of no EDRs 11 that are definitely clean. This can happen if, for example, a subscriber contacts their network operator to report suspicious activity. In this case, the preprocessor 15 step is omitted, and only unsupervised classifiers and novelty detectors can produce an output. Unsupervised classifiers can operate even if no EDRs 11 are labeled as fraudulent or have SBAs 13 associated with them by attempting to decompose the EDR data 11 into subsets that satisfy certain statistical criteria. Provided that these criteria are appropriately selected, clean and fraudulent EDRs can be efficiently separated into different subsets. These subsets can then be analyzed (by a series of rules, for example) and classified according to their characteristics. Any unsupervised algorithm, such as a self-organizing feature map, a vector quantizer, or segmentation algorithm, etc., can be used in the unsupervised classifier component, provided that it is sufficiently fast for the invention to be used interactively.

Novelty detectors perform a novelty detection algorithm. In one embodiment, novelty detection algorithms needs only a list of clean or fraud EDRs 12, but not both. They use these EDRs to build a model of either non-fraudulent or fraudulent behavior and search the remaining EDR data 11 for behavior that is inconsistent with the model. Novelty detection can be performed in any of the standard ways, such as searching for feature values that are beyond a percentile of the distribution of values of the feature in the clean EDRs, or producing a model of the probability density of values of a feature, or set of features, and searching for EDRs where the values lie in a region where the density is below a threshold. More sophisticated techniques can also be used, such as the recently developed one-class support vector machine, provided that they are fast enough for the invention to be interactive.

If the outputs 19 of the classifier unit 18 do not lie in the interval [0,1], they need to be scaled into that range in such a way that a value close to one indicates that an event is probably fraudulent. This can always be achieved using either a linear or non-linear scaling (such as is produced by applying the logistic function). The results 19 from the classifier unit 18 are passed back to a user 110, and forward to the feature results combiner 111. The results are useful to the user of the invention because they can provide insight into the characteristics by which the fraudulent behavior differs from non-fraudulent behavior, which can make it easier for the user to distinguish between the two. For example, the classifier results can provide information that fraud is characterized by long duration high cost calls to numbers starting with a ‘9’, whereas clean calls have a short duration, cost less, are less frequent, and are usually made to numbers starting with a ‘1’.

The feature results combiner 111 combines the outputs of the individual classifiers into a single propensity measure 112 that is associated with each EDR. These propensities lie in the range [0,1] and indicate the likelihood that each EDR was generated in response to a fraudulent event. To compute the propensities, the feature results combiner calculates a weighted sum of the outputs of the classifiers. The weight assigned to a classifier is calculated using the following formula:

$$w = \frac{1}{1 + α \cdot r} where$$

$$r = \frac{\frac{\text{Sum of classifier outputs for clean} EDRs}{\text{Number of clean} EDRs}}{\frac{\text{Sum of classifier outputs for fraud} EDRs}{\text{Number of fraud} EDRs}}$$

and α is a parameter that controls the sensitivity of the weight to the performance of the classifier on the clean and fraud EDRs 12.

For example, if α is zero, all classifiers are weighted equally in the feature results combiner 111 regardless of how well their outputs match the known distribution of clean and fraud EDRs 12. If, on the other hand, a has a large value like 1,000,000, classifiers that perform poorly (those that tend to output low values for fraud EDRs and large ones for clean EDRs) will be assigned small weights and hence have little affect on the propensities output by the invention. A value of 5,000 has been found to work well in practice, though the optimal value of α should be expected to change with different features. If there are no EDRs that are known to be fraudulent or no EDRs that are known to be clean, the outputs of all classifiers are combined equally.

Alternative ways of combining the feature classifier outputs are also possible, such as finding the combination of weights that minimizes some measure of the error between the combined propensities over clean and fraud EDRs 12 and an indicator variable that takes the value zero for a clean EDR and one for a fraud EDR. Although these schemes may produce better overall propensities (which discriminate more accurately between clean and fraud EDRs) the simpler weighting scheme described in detail above performs well in practice and is very fast. It is also sometimes useful to non-linearly process the propensities output by the feature results combiner 111 in order to accentuate the differences in them between clean and fraud EDRs 12. This can be done by passing the propensities through a non-linear transformation such as the logistic function.

If the function contains parameters, the optimal values of the parameters (those that discriminate most strongly between the clean and fraud EDRs) can be found using well established methods (such as treating the processed propensities 112 as probabilities and maximizing the likelihood of the known clean and fraud EDRs). Although these techniques can increase the discriminatory power of the propensities, they are not used in most practical deployments of the invention because a simple weighted sum of propensities produces good discrimination and is fast and efficient. Finally, so that the propensities can be interpreted as approximations to the probability that an EDR is fraudulent, they need to be scaled to lie in the range [0,1] by dividing by the largest propensity.

An important aspect of the invention is that when a fraud analyst receives the propensities it produces, they can revise their list of clean and fraud EDRs 12, re-invoke the system, and get a revised (and usually more discriminatory) set of propensities 112. In this way, in one embodiment, only a small number of iterations and several minutes are required to reliably identify the fraudulent events in an archive of perhaps several thousand EDRs. Attempting to identify these events without the use of the invention would take a single fraud analyst much longer with an additional and substantial risk that a large number of fraudulent events would be misclassified as clean and vice versa.

FIG. 3 shows an example of the propensities output by the invention for 5,000 EDRs from a real case of fraud. The fraud is clearly represented by the four large blocks of contiguous EDRs that have propensities greater than 0.8.

The present invention is a novel system that provides a configurable real time interactive decision support tool to help fraud analysts identify and remove fraudulent events from an event data archive. The present invention can be operated in an interactive real time manner that analyses the event archives of subscribers and highlights fraudulent events, allowing fraud analysts to quickly and efficiently identify fraudulent events and remove them from the billing system without also removing non-fraudulent ones.

The skilled addressee will realize that modifications and variations may be made to the present invention without departing from the basic inventive concept. Such modifications include changes within the information flow within the invention or the duplication or removal of some of the processing modules. For example, some feature extraction algorithms could make use of information about which events are known to be clean or fraudulent even though the flow of that information into the feature extraction module is not shown in FIG. 1. Similarly, some embodiments may not require a feature extraction module at all if the data in the event records is suitable for immediate input to the invention's classifiers.

The skilled addressee will realize that the present invention has application in field other than fraud detection in a telecommunications network. For example, it could also be used to identify other events corresponding to frauds in an event archive outside of the telecommunications industry. In particular, it could be used to identify fraudulent credit card transactions based on records of transaction value, location, and time.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of classifying a plurality of records associated with an event, the method comprising:
providing a plurality of event data records;
extracting numeric values from each event data record; and
classifying the numeric values of each event data record to produce a propensity value associated with each event data record,
wherein the propensity value is used as a probability that an event associated with each event data record satisfies a criterion.

2. A method according to claim 1, further comprising:
providing suspect behavior alerts generated in response to one or more of the event data records potentially being generated by the criterion sought;
preprocessing the suspect behavior alerts to remove alerts that are false positives before the classifying; and
using the preprocessed suspect behavior alerts in the classifying.

3. A method according to claim 1, wherein the criterion being sought may be a fraud event.

4. A system for classifying a plurality of records associated with an event, the system comprising:
a receiver configured to receive a plurality of event data records;
an extractor configured to extract numeric values from each event data record; and
a classifier unit configured to classify the numeric values of each event data record to produce a propensity value associated with each event data record, the propensity value being a probability that an event associated with each event data record satisfies a criterion.

5. A system according to claim 4, further comprising:
a receiver configured to receive suspect behavior alerts generated in response to one or more of the event data records potentially being generated by a sought criterion; and
a preprocessor configured to preprocess the suspect behavior alerts to remove alerts that are false positives; and
a module configured to provide the preprocessed suspect behavior alerts to the classifier unit.

6. A system according to claim 4, wherein the criterion being sought may be a fraud event.

7. A method of classifying a plurality of records associated with an event, the method comprising:
providing a plurality of event data records;
providing suspect behavior alerts generated in response to one or more of the event data records potentially being generated by a fraud;
preprocessing the suspect behavior alerts to remove alerts that are false positives;
extracting numeric values from each event data record;
classifying the numeric values of each event data record to produce a propensity value associated with each event data record, the propensity value being a probability that an event associated with each event data record is suspicious, wherein the propensity value is configured to assist in classifying each event as suspicious or not.

8. A method according to claim 7, wherein the event data records are generated within a telecommunications network and contain data pertaining to events within the network.

9. A method according to claim 7, wherein the event data records are archived in a data warehouse.

10. A method according to claim 7, wherein a fraud detection system generates suspect behavior alerts in response to one or more event data records being considered to be potentially from fraudulent use of the network.

11. A method according to claim 7, wherein a suspect behavior alert is generated in response to either an individual event data record or a group of event data records, or both.

12. A method according to claim 11, wherein the suspect behavior alert includes data associated with an event data record that indicates which components of the fraud detection engine consider the event data record to be suspicious.

13. A method according to claim 12, wherein the preprocessing uses all suspect behavior alerts and event data records associated with the service supplied to a particular subscriber of the service.

14. A method according to claim 13, wherein the preprocessing also uses a list of event data records that are known not to be part of the fraud (clean records) and a list of event data records that are known to be part of the fraud.

15. A method according to claim 14, wherein the preprocessing comprises one or more of the following:
(a) removing suspect behavior alerts that correspond to event data records known to be clean;
(b) dividing the suspect behavior alerts into contiguous blocks where at least a minimum number of suspect behavior alerts were generated for each event data record;
(c) removing suspect behavior alerts where there is less than a threshold number of suspect behavior alerts for each event data record in each contiguous block of event data records; and
(d) removing suspect behavior alerts that are part of one of the blocks that contains fewer suspect behavior alerts than a percentile of the lengths of all contiguous blocks of suspect behavior alerts.

16. A method according to claim 15, wherein (d) is applied prior to (a) and (c) in noisy environments.

17. A method according to claim 15, wherein if the number of blocks of suspect behavior alerts produced by (a) and (c) is small, then (d) is omitted.

18. A method according to claim 7, wherein the numeric values extracted from data are through the application of one or more linear or non-linear functions.

19. A method according to claim 7, wherein the classification comprises applying one or more classifying methods to the numeric values.

20. A method according to claim 19, wherein the classifying methods include one or more of the following: a supervised classifier, an unsupervised classifier and a novelty detector.

21. A method according to claim 20, wherein the supervised classifier method uses features extracted from both the clean records, the known fraud records, and the event data records associated with preprocessed suspect behavior alerts to build classifiers that are able to discriminate between known frauds and non-frauds.

22. A method according to claim 20, wherein the supervised classifier is one or more of the following: a neural network, a decision tree, a parametric discriminant, semi-parametric discriminant, or non-parametric discriminant.

23. A method according to claim 20, wherein unsupervised classifier method decomposes the extracted data into subsets that satisfy selected statistical criteria to produce event data record subsets, the subsets are then analyzed and classified according to their characteristics.

24. A method according to claim 20, wherein the unsupervised algorithm is one or more of the following: a self-organizing feature map, a vector quantizer, or a segmentation algorithm.

25. A method according to claim 20, wherein the preprocessor is omitted when a fraud occurs without any suspect behavior alerts having been generated, and only unsupervised classifier methods and/or novelty detector methods within the classification step are used.

26. A method according to claim 20, wherein the novelty detection algorithm uses either a list of clean data records or a list of fraud event data records, wherein the novelty detection algorithm builds models of either non-fraudulent or fraudulent behavior and searches the remaining extracted data for behavior that is inconsistent with these models.

27. A method according to claim 20, wherein the novelty detection algorithm searches for feature values that are beyond a percentile of the distribution of values of the feature in the clean event data records.

28. A method according to claim 20, wherein the novelty detection algorithm produces a model of the probability density of values of a feature, or set of features, and searches for event data records where the values lie in a region where the density is below a threshold.

29. A method according to claim 20, wherein the outputs of the classifier methods are combined into a single propensity measure that is associated with each event data record component, the propensity measure indicating the likelihood that each event data record was generated in response to a fraudulent event.

30. A method according to claim 29, wherein the propensities are calculated from a weighted sum of the outputs of the classifiers.

31. A method according to claim 29, wherein if there are no event data records that are known to be fraudulent or no event data records that are known to be clean, the outputs of all classifiers are combined equally.

32. A method according to claim 29, wherein the combination of weights minimizes a measure of the error between the combined propensities over clean and fraud event data records and an indicator variable that takes the value zero for a clean event data record and one for a fraud event data record.

33. A method according to claim 7, wherein a fraud analyst can revise the lists of clean and fraud event data records from the received the propensities.

34. A method according to claim 33, wherein the method can be reapplied to get a revised set of propensities.

35. A system for classifying a plurality of records associated with an event, the system comprising:
a receiver configured to receive a plurality of event data records and suspect behavior alerts generated in response to one or more of the event data records potentially being generated by a fraud;
an extractor configured to extract numeric values from each event data record; and
a classifier unit configured to classify the numeric values of each event data record to produce a propensity value associated with each event data record, the propensity value being a probability that an event associated with each event data record is suspicious or not.

36. A system according to claim 35, further comprising a preprocessor configured to remove suspect behavior alerts that are false positives.

37. A system according to claim 35, wherein the event data records are generated within a telecommunications network and contain data pertaining to events within the network.

38. A system according to claim 35, wherein the event data records are archived in a data warehouse and are provided to the receiver.

39. A system according to claim 36, wherein the preprocessor is arranged to receive all suspect behavior alerts and event data records associated with the service supplied to a particular subscriber of the service.

40. A system according to claim 39, wherein the preprocessor is further arranged to receive a list of event data records that are known not to be part of the fraud (clean records) and a list of event data records that are known to be part of the fraud.

41. A system according to claim 36, wherein the preprocessor comprises a process configured to remove suspect behavior alerts that correspond to event data records known to be clean.

42. A system according to claim 36, wherein the preprocessor comprises a process configured to divide the suspect behavior alerts into contiguous blocks where at least a minimum number of suspect behavior alerts were generated for each event data record.

43. A system according to claim 36, wherein the preprocessor comprises a process configured to remove suspect behavior alerts where there is less than a threshold number of suspect behavior of alerts for each event data record in each contiguous block of event data records.

44. A system according to claim 36, wherein the preprocessor comprises a process configured to remove suspect behavior alerts that are part of one of the blocks that contains fewer suspect behavior alerts than a percentile of the lengths of all contiguous blocks of suspect behavior alerts.

45. A system according to claim 35, further comprising a feature extraction component configured to extract a numeric value from data is through the application of one or more linear or non-linear functions.

46. A system according to claim 35, wherein the classifier unit comprises a supervised classifier.

47. A system according to claim 35, wherein the classifier unit comprises an unsupervised classifier.

48. A system according to claim 35, wherein the classifier unit comprises a novelty detector.

49. A system according to claim 46, wherein the supervised classifier is one or more of the following: a neural network, a decision tree, a parametric discriminant, semi-parametric discriminant, or non-parametric discriminant.

50. A system according to claim 47, wherein the unsupervised classifier is one or more of the following: a self-organizing feature map, a vector quantizer, or a segmentation algorithm.

51. A system according to claim 48, wherein the novelty detector includes a detection section configured to search for feature values that are beyond a percentile of the distribution of values of the feature in the clean event data records.

52. A system according to claim 35, wherein the classifier unit comprises a plurality of classifiers, and the system further comprises a combiner configured to combine the outputs of the classifiers into a single propensity measure that is associated with each event data record component.

53. A system for classifying a plurality of records associated with an event, the system comprising:
means for providing a plurality of event data records;
means for extracting numeric values from each event data record; and
means for classifying the numeric values of each event data record to produce a propensity value associated with each event data record,
wherein the propensity value is used as a probability that an event associated with each event data record satisfies a criterion.
